(19) United States
(12) Patent Application Publication
(10) Pub. No.: US 2022/0024433 A1
(43) Pub. Date: Jan. 27, 2022

(54) ELECTRIC MOTOR-DRIVEN BRAKE DEVICE

(71) Applicant: Mitsubishi Electric Corporation, Tokyo (JP)

(72) Inventors: Atsushi YUYAMA, Tokyo (JP); Chiharu Morisaki, Tokyo (JP)

(73) Assignee: Mitsubishi Electric Corporation, Tokyo (JP)

(21) Appl. No.: 17/342,801

(22) Filed: Jun. 9, 2021

(30) Foreign Application Priority Data
Jul. 27, 2020 (JP) 2020-126096

(51) Int. Cl. B60T 13/74; B60T 8/171; F16D 65/18

(52) U.S. Cl. CPC B60T 13/741; B60T 8/171; F16D 2121/24; B60T 2250/04; B60T 2250/03; F16D 65/18

(57) ABSTRACT

An electric motor-driven brake device for use in a wheeled vehicle is provided with low costs which appropriately enables the wheeled vehicle running and stopping as it usually does, even when a malfunction and/or abnormality are/is caused in the electric motor-driven brake device. Signal lines of stroke sensors each for detecting the quantity of stroke of a brake pedal are connected to controllers in an electric motor-drive unit for controlling a motor which drives an electric motor-driven piston of a brake pad(s) attached thereat.

### BACKGROUND OF THE INVENTION

### Field of the invention

The disclosure of the present application relates to an electric motor-driven brake device for controlling braking force of a wheeled vehicle using an electric motor-drive unit.

### Description of the Related Art

As an alternative means of an oil-hydraulic brake device having conventionally been used, developments have been underway for an electric motor-driven brake device which obtains braking pressure or force of a wheeled vehicle by driving an electric motor. A brake device carries important functions of a wheeled vehicle, and so, even when a malfunction is caused in the brake device, it is essential to make a system redundant so that the wheeled vehicle can appropriately run and stop as it usually does.

For example, in Patent Document 1, an electric motor-driven brake device for use in a wheeled vehicle is disclosed in which a motor for operating a motor-driven piston is made as a dual-redundant system together with inverters, so that, even when a motor or an inverter on one side malfunctions, the operations of the motor-driven piston can be continued by driving the motor by means of a motor or an inverter on the other side.

### PATENT DOCUMENT

[Patent Document 1] Japanese Patent. Publication No. 6628705

In Patent Document 1, a motor for operating a motor-driven piston is made as a dual-redundant system together with the inverters, so that, even when either of them malfunctions, it is so arranged that the operations of the motor-driven piston can be continued; however, because a controller for calculating braking force required for the wheeled vehicle is not made as a dual-redundant system, it is not possible to continue the operations of the motor-driven piston when the controller malfunctions. In addition, braking force required for a wheeled vehicle is calculated by inputting the quantity of stroke detected by a stroke sensor of a brake pedal and the like into a controller; however, these inputs are not also be made as a dual-redundant system, so that the operations of the motor-driven piston cannot be continued when the quantity of stroke detected by the stroke sensor stops being inputted into the controller due to a disconnection of its signal line or the like. Moreover, there also arises a problem in that, when a system is simply made dual-redundant, the number of its components increases, which results in higher costs.

### SUMMARY OF THE INVENTION

The present disclosure of the application concerned has been directed at solving those problems described above, and an object of the present disclosure is to provide an electric motor-driven brake device for use in a wheeled vehicle with low costs in which the electric motor-driven brake device appropriately enables the wheeled vehicle running and stopping as it usually does, even when a malfunction and/or abnormality are/is caused in the electric motor-driven brake device.

An electric motor-driven brake device disclosed in the present disclosure of the application concerned comprises: a disc rotor(s) for rotating together with an axle of an automotive wheel of a wheeled vehicle; a brake pad, by means of pressing it against the disc rotor(s), for producing braking force of the wheeled vehicle; an electric motor-driven piston(s), being driven by a motor(s), for pressing the brake pad against the disc rotor(s), or for disengaging the brake pad from the disc rotor(s); an electric motor-drive unit for controlling the drive of the electric motor-driven piston(s) by controlling the motor(s) thereof; and a stroke sensor (s) for detecting the quantity of stroke of a brake pedal, wherein, in the electric motor-driven brake device for controlling braking force on the automotive wheel of the wheeled vehicle by means of the electric motor-drive unit in accordance with the quantity of stroke being detected, the electric motor-drive unit comprises a first controller and a second controller each for driving the motor(s), and signal lines of the stroke sensor (s) are connected to both of the first controller and the second controller.

According to the electric motor-driven brake device disclosed in the present disclosure of the application concerned, the electric motor-driven brake device appropriately enables a wheeled vehicle running and stopping as it usually does, even in a case in which a malfunction is caused in a component(s) related to the electric motor-driven brake device of the wheeled vehicle. In addition, it is possible to implement the electric motor-driven brake device with low costs.

### BRIEF DESCRIPTION OF DRAWINGS

FIG. 1 is a schematic diagram illustrating a configuration of a electric motor-driven brake device according to Embodiment 1;

FIG. 2 is a circuit diagram illustrating the principal configuration of an electric system composing the electric motor-driven brake device according to Embodiment 1;

FIG. 3 is a schematic diagram illustrating a configuration of an electric motor-driven brake device according to Embodiment 2;

FIG. 4 a schematic diagram illustrating a configuration of an electric motor-driven brake device according to Embodiment 3;

FIG. 5 is a schematic diagram illustrating a configuration of an electric motor-driven brake device according to Embodiment 4;

FIG. 6 is a schematic diagram illustrating a configuration of an electric motor-driven brake device according to Embodiment 5;

FIG. 7 is a schematic diagram illustrating a configuration of an electric motor-driven brake device according to Embodiment 6;

FIG. 8 is a schematic diagram illustrating a configuration of an electric motor-driven brake device according to Embodiment 7; and

FIG. 9 is a schematic diagram illustrating a modification example of an electric motor-driven brake device according to Embodiment 7.

### DETAILED DESCRIPTION OF THE PREFERRED EMBODIMENTS

Hereinafter, the explanation will be made for each of embodiments of electric motor-driven brake devices according to the embodiments referring to the drawings attached to the application. It should be noted that, in each of the figures, the same or corresponding items, portions or parts designate the same reference numerals and symbols.

### Embodiment 1

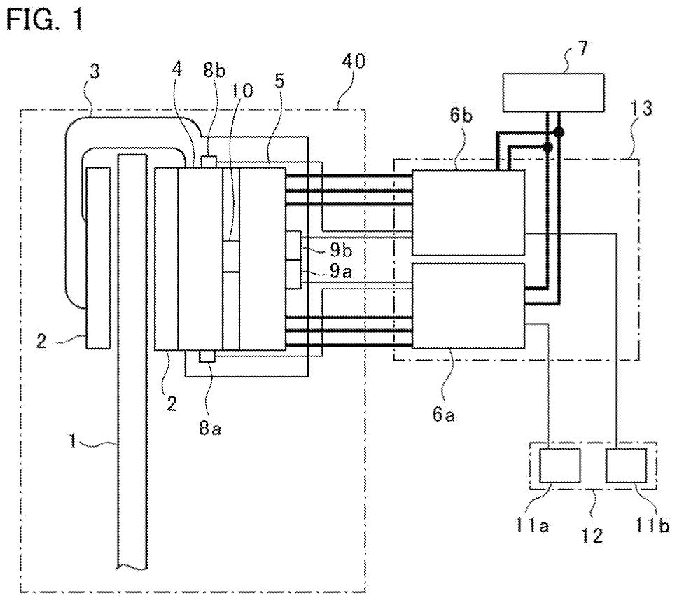

The explanation will be made referring to FIG. 1 for a configuration of an electric motor-driven brake device. FIG. 1 illustrates a schematic diagram for explaining the configuration of the electric motor-driven brake device according to Embodiment 1.

The electric motor-driven brake device includes a disc rotor 1 as illustrated in FIG. 1, being attached on an axle of an automotive wheel (not shown in the figure) of a wheeled vehicle (not shown in the figure), for rotating together with the axle of the automotive wheel, and, when the disc rotor 1 is pressed by a pair of brake pads 2, frictional force is caused therebetween, so that decelerating- and braking-force of the wheeled vehicle is produced due to the frictional force.

A caliper 3 is movably supported on a side of a vehicle body of the wheeled vehicle so that the caliper is enabled to shift in left-hand and right-hand directions of FIG. 1, and, on the caliper 3, a motor 5 including a drive shaft 10 is fixed; and, in addition, on the caliper 3, an electric motor-driven piston 4 is attached so that it shifts in the left-hand and right-hand directions of FIG. 1 when it is driven by the motor 5.

The motor 5 is a dual-winding three-phase motor having a stator including thereon two independent groups of coil windings with respect to a single disc rotor. The electric motor-driven brake device includes controllers (electric power converters) 6a and 6b for supplying electric power to the motor 5 and also for controlling the operations (a rotational direction, a rotational speed, and torque), and an electric power source 7 (for example, a lead-acid battery, a nickel metal hydride battery, a lithium (Li) ion battery, and/or a capacitor) for supplying electric power to the controllers 6a and 6b and for receiving electric power therefrom; and, by supplying electric power from the controllers 6a and 6b (first controller 6a and second controller 6b) to the motor 5, the drive shaft 10 rotates normally or reversely, so that the electric motor-driven piston 4 shifts reciprocally in the axial direction (left-hand and right-hand directions of FIG. 1). Here, the controllers 6a and 6b are each connected through their connection lines so that one of the two groups of coil windings of the motor 5 can be individually energized.

At a front-end portion of the caliper 3 opposing to one face of the disc rotor 1 (left-side face in FIG. 1) and at a front-end portion of the electric motor-driven piston 4 opposing to the other face of the disc rotor 1 (right-side face in FIG. 1), the respective brake pads 2 are attached.

As operational examples, when the drive shaft 10 of the motor 5 rotates in a normal direction, the electric motor-driven piston 4 shifts in the left-hand direction of FIG. 1 and the brake pad 2 attached at the front end of the electric motor-driven piston 4 is pressed onto the disc rotor 1, and, at the same time, the caliper 3 shifts in the right-hand direction of FIG. 1 due to reaction force thereto, so that the disc rotor 1 is pressed by means of the pair of brake pads 2. According to the operations, decelerating- and braking-force is produced. Meanwhile, when the drive shaft 10 of the motor 5 rotates in a reverse direction, the electric motor-driven piston 4 shifts in the right-hand direction of FIG. 1, and the caliper 3 having then shifted due to the reaction force thereto shifts in the left-hand direction of FIG. 1, so that the pair of brake pads 2 are disengaged from the disc rotor 1. According to the operations, the decelerating- and braking-force is released.

On the wheeled. vehicle, a brake pedal 12 is included, and, on the brake pedal 12, stroke sensors 11a and 11b (first stroke sensor 11a and second stroke sensor 11b) are mounted for detecting the quantity of its stroke of depression. A stroke-quantity signal detected by the stroke sensor 11a is inputted into the controller 6a, and a stroke-quantity signal detected by the stroke sensor 11b is inputted into the controller 6b. Namely, signal lines of the stroke sensors with respect to the brake pedal 12 are connected to both of the first controller 6a and the second controller 6b. It should be noted that a stroke sensor of the brake pedal 12 may be made as a single sensor, and its signal line is so arranged as to be connected to both of the first controller 6a and the second controller 6b.

The calculation is performed by means of the controllers 6a and 6b each on a target value(s) of a pressure-load obtainable by pressing the brake pads 2 against the disc rotor 1 (hereinafter referred as “pressing force”) being required for obtaining decelerating- and braking-force required for a wheeled vehicle or for obtaining such force therefor, based on at least the stroke-quantity signals described above. Electric power is supplied to the motor 5 so as to achieve decelerating- and braking-force required for a wheeled vehicle, or pressing force therefor, having been calculated, so that, by rotating the motor in the normal or reverse direction, the brake pads 2 operate to press them against the disc rotor 1 or disengage them from the disc rotor.

On the electric motor-driven piston 4, mounted are load sensors 8a and 8b each for detecting how much the disc rotor 1 is pressed by means of the brake pads 2, so that a pressure-load signal detected by means of the load sensor 8a is inputted into the controller 6a, and a pressure-load signal detected by means of the load sensor 8b is inputted into the controller 6b.

On the motor 5, rotation angle sensors 9a and 9b each for detecting a rotation angle about the drive shaft 10 are mounted, so that a rotation angle signal detected by means of the rotation angle sensor 9a is inputted into the controller 6a, and a rotation angle signal detected by means of the rotation angle sensor 9b inputted into the controller 6b.

Also mounted are motor current sensors (not shown in the figure) each for detecting electric currents flowing through connection lines between the motor 5 and the controllers 6a and 6b for use in electric power supply/reception therebetween, so that motor current signals are individually inputted into the controllers 6a and 6b, and the controllers 6a and 6b perform, for example, a feedback control on the motor 5 based on pressure-load signals, and rotation angles and/or the motor current signals each being inputted.

It should be noted that an electric motor-drive unit 13 is constituted of the controllers 6a and 6b. In addition, a brake mechanism 40 made of a brake actuator is constituted of the disc rotor 1, the brake pads 2, the caliper 3, the electric motor-driven piston 4, the motor 5, and so forth.

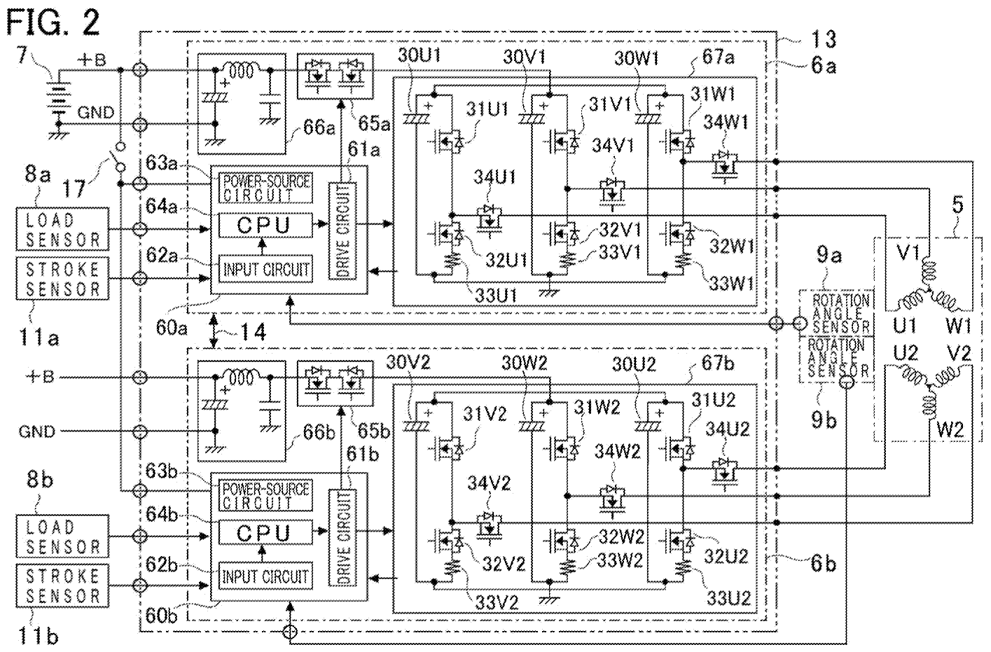

Next, the explanation will be made in detail referring to FIG. 2 for the controllers 6a and 6b. FIG. 2 is a circuit diagram illustrating the principal configuration of an electric system composing the electric motor-driven brake device according to Embodiment 1.

In the figure, the controllers 6a and 6b are controllers each of which controls to drive the motor 5 including two groups of three-phase coil windings, and thus to operate the brake actuator; and the controllers are constituted of so-called inverter circuits 67a and 67b, control circuitry 60a and 60b mounting thereon central processing units (hereinafter referred to as “CPUs”) 64a and 64b, power-relay switching devices 65a and 65b forming power-relay circuits, and so forth, respectively. In addition, from the electric power source 7 mounted on the wheeled vehicle, electric power is supplied to the control circuitry 60a and 60b by way of an ignition switch 17, and then of power-source circuits a and 63b, respectively.

Moreover, inputted into the control circuitry 60a and 60b is the information from the load sensors 8a and 8b being mounted in vicinity to the brake actuator for detecting pressing force of the brake actuator, the information from the stroke sensors 11a and 11b for detecting the quantity of stroke when a brake pedal (not shown in the figure) is depressed, and so forth. Note that, for the electric motor-drive unit 13, multiple terminals for connecting to external devices are provided, and, to be specific, the placement is achieved for the electric motor-drive unit by fixing connectors on its circuit board(s).

The information from various kinds of sensors is transmitted to the CPUs 64a and 64b by way of input circuits 62a and 62b of the control circuitry 60a and 60b, respectively. The CPUs 64a and 64b calculate, based on the information having been inputted thereinto, electric current values for rotating the motor 5, and then output control signals to drive circuits 61a and 61b, respectively. The drive circuits 61a and 61b output, by individually receiving their input signals, control signals for controlling each of switching devices of the inverter circuits 67a and 67b constituting output circuits, respectively.

Note that, because only small currents flow in the drive circuits 61a and 61b, they are placed in the control circuitry 60a and 60b; however, they may be placed in the inverter circuits 67a and 67b, respectively.

In addition, the inverter circuits 67a and 67b have the same circuit configurations with respect to each phase of coil windings (U1, V1, W1) and to that of coil windings (U2, V2, W2), so that the inverter circuits are configured in such a manner that they can supply electric currents independently to each phase of the coil windings. In the inverter circuits 67a and 67b, provided are upper- and lower-arm switching devices (31U1, 31V1 and 31W1, and 32U1, 32V1 and 32W1) for supplying output currents into the three-phase coil windings (U1, V1, W1) of the motor 5, and into the respective three-phase coil windings (U2, V2, W2) thereof; and, in the inverter circuit 67a, provided are motor-relay switching devices 34U1, 34V1 and 34W1 for connecting or disconnecting electrical wiring lines with the coil windings U1, V1 and W1 of the motor 5, shunt resistors 33U1, 33V1 and 33W1 for use in electric currents detection, and noise suppression capacitors 30U1, 30V1 and 30W1, respectively.

Moreover, electric potential differences across both terminals of the shunt resistors 33U1, 33V1 and 33W1, and thus voltages at coil winding terminals of the motor 5, for example, or the like are also inputted into the input circuits 62a and 62b. It is configured in such a manner that the information described above is also inputted into the CPUs 64a and 64b, and the difference from a detection value corresponding to an electric current value having been calculated is then calculated, so that a so-called feedback control is performed; and thus, the brake actuator is driven by supplying required motor currents thereto.

Note that, respective control signals of the power-relay switching devices 65a and 65b are also outputted from the drive circuits 61a and 61b, so that the supplies of electric currents into the motor 5 can be disconnected by means of these power-relay switching devices 65a and 65b. In a similar manner, the motor-relay switching devices 34U1, 34V1 and 34W1 can also independently disconnect the supplies of electric currents into the motor 5.

Here, in order to suppress the emission of noise due to pulse width modulations in the inverter circuits 67a and 67b, respective filters 66a and 66b each made of capacitors and of a coil are connected to electric power-source terminals (+B, and GND) of the electric power source 7. In addition, because the power-relay switching devices 65a and 65b generate heat due to large electric currents flowing through them, it may be configured that they are individually built in the inverter circuits 67a and 67b, and that they are coupled with heat dissipaters or heatsinks of the inverter circuits 67a and 67b so as to dissipate the heat from the heatsinks.

It should be noted that there also arises no problem in not mounting on the controllers the noise suppression capacitors, the power relays, the motor relays and/or the filters on an as-needed basis.

By the way, the CPUs 64a and 64b include abnormality detection functions for detecting, from various kinds of information having been inputted, respective abnormality of the inverter circuits 67a and 67b, the coil windings (U1, V1, W1), the coil windings (U2, V2, W2) and the like, so that, when abnormality is detected, the power-relay switching devices 65a and/or 65b are/is turned off in accordance with the abnormality, and the electric power source 7 to the inverter circuits is disconnected, disconnect the supply of an electric current to the motor by turning off only a predetermined phase of the motor-relay switching devices 34U1, 34V1 or 34W1. Moreover, it may be configured that, when abnormality is detected, the CPUs 64a and/or 64b supply electric power into a notification device (not shown in the figure) of a lamp, for example, or the like by way of the drive circuits 61a and/or 61b so as to power it on.

Meanwhile, the motor 5 is a brushless motor whose two groups of three-phase coil windings are made in the form of star connection, and the rotation angle sensors 9a and 9b each for detecting a rotational position of the rotor are mounted. Also on the rotation angle sensors 9a and 9b, two groups of sensors are individually mounted in order to secure a redundant system, and the information on the rotation of the rotor is transmitted to the input circuits 62a and 62b of the control circuitry 60a and 60b, respectively.

Note that, the motor 5 may not be the brushless motor in the form of three-phase star connection, but may be a brushless motor in the form of three-phase delta connection, or may also be a brush motor in the form of two pairs of dipoles. In addition, as for the specification of coil windings, they may be distributed windings or concentrated windings. However, it is necessary to configure the coil windings in such a manner that, only in one group of coil windings, or even in two groups of coil windings, a desired number of motor's revolutions and torque can be outputted from the motor.

In addition, signals from the load sensors 8a and 8b are also inputted into the input circuits 62a and 62b, respectively. It is possible to configure in such a manner that the information of these signals is also inputted into the CPUs 64a and 64b, and the difference from a detection value corresponding to a pressure-load value having been calculated is then calculated, so that a so-called feedback control is performed.

Moreover, signals from the rotation angle sensors 9a and 9b are also inputted into the input circuits 62a and 62b, respectively. It is also possible to configure in such a manner that the information of these signals is also inputted into the CPUs 64a and 64b, so that a feedforward control is performed which controls a pressure-load by estimating it at a position of the electric motor-driven piston calculated from a rotation angle. According to these controls, the brake actuator is driven.

Here, signals of the stroke sensors 11a and 11b are also inputted into the input circuits 62a and 62b, respectively. The information of these signals is also inputted into the CPUs 64a and 64b, so that, based on the stroke-quantity signals, target values of decelerating- and braking-force required for a wheeled vehicle, or pressing force required for obtaining such force are calculated in the CPUs 64a and 64b. In accordance with these target values, the pressure-load is controlled.

As described above, the controllers 6a and 6b are configured in such a manner that they can individually drive the motor 5, independent of each other, by independently using input information, a calculation value (s) and a detection value(s).

Inputs of the stroke sensors are individually provided for the CPUs 64a and 64b, and target values of decelerating- and braking-force required for a wheeled vehicle, or pressing force required for obtaining such force are calculated by both of the CPUs. And thus, even when an input of a stroke sensor into one CPU is disconnected or when a CPU malfunctions, it becomes possible to continue the controls by using a calculation result of the other CPU, so that the electric motor-driven brake device appropriately enables a wheeled vehicle running and stopping as it usually does, even in a case in which a malfunction is caused in a component(s) related to the electric motor-driven brake device of the wheeled vehicle. In addition, the controllers 6a and 6b are intensively made into the single-piece electric motor-drive unit 13 that is integrally configured as one unit as shown in FIG. 1, and also, in addition to the function to drive the motor 5, the controllers 6a and 6b are also given to carry the function to calculate from various kinds of sensor inputs target values of decelerating- and braking-force required for the wheeled vehicle, or pressing force required for obtaining such force, so that, on the occasion to make individual functions dual-redundant as a system, it is possible to cope only with the increase of an interface or with that of an input circuit without creating another unit; and thus, it is possible to implement those functions with low costs.

Moreover, between both of the CPUs 64a and 64b, a communications line 14 is connected so that transmission/reception of data and/or information can be performed therebetween. By means of the transmission/reception of information by way of the communications line 14, it become possible to individually grasp operating conditions of the CPUs 64a and 64b on one party to the other. For example, it is possible to transmit to the CPU 64b an event in which the CPU 64a detects abnormality, so that a predetermined switching device(s) is turned off. If there arises a case in which abnormality occurs in the CPU 64a or 64b itself, the transmission/reception of a regular communications signal in accordance with a predetermined format cannot be performed any more, whereby one CPU is also enabled to grasp an occurrence of abnormality on the other CPU.

In addition to the above, by means of the communications line 14, it is possible to drive the drive circuits 61a and 61b by synchronizing them. By driving them with appropriate phase differences between them, effects can also be achieved as the reduction of voltage ripples, the reduction of electromagnetic sound, and the reduction of noise.

Furthermore, an electric power-source sensor (not shown in the figure) for detecting a voltage of the electric power source 7, and electric power-source current sensors (not shown in the figure) for detecting electric currents from the electric power source 7 into the controllers 6a and 6b may also be included. And, by inputting an electric power-source's voltage signal of the sensor and electric power-source's current signals of those sensors into the CPUs 64a and 64b by way of the input circuits 62a and 62b, and by being based on those signals, it may also be adopted that: detection values of various kinds of sensors are compensated; target values of decelerating- and braking-force required for a wheeled vehicle, or pressing force required for obtaining such force by means of the CPUs 64a and 64b are compensated; and the control of motor currents for energizing the motor 5 is compensated.

### Embodiment 2

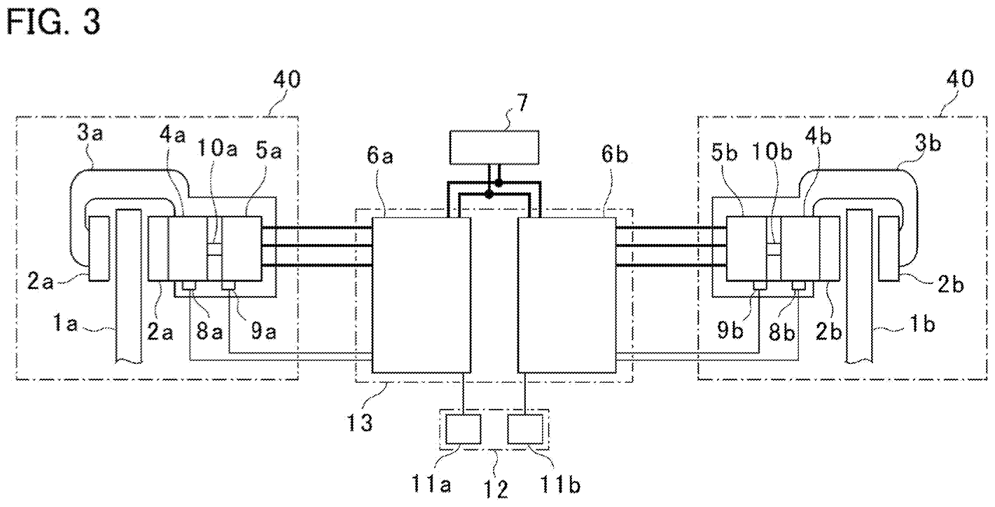

The explanation will be made referring to FIG. 3 for a configuration of an electric motor-driven brake device. FIG. 3 illustrates a schematic diagram for explaining the configuration of the electric motor-driven brake device according to Embodiment 2.

The electric motor-driven brake device includes disc rotors 1a and 1b as illustrated in FIG. 3, each being attached on an axle (s) of an automotive wheel (s) (not shown in the figure) of a wheeled vehicle (not shown in the figure), for rotating together with the axle (s) of the automotive wheel(s). And, when the disc rotors 1a and 1b are each pressed by pairs of brake pads 2a and 2b, frictional force is caused therebetween, so that decelerating- and braking-force of the wheeled vehicle is produced due to the frictional force, respectively.

Calipers 3a and 3b are movably supported on a side of a vehicle body of the wheeled vehicle so that the calipers 3a and 3b are enabled to shift in left-hand and right-hand directions of FIG. 3, and, on the calipers 3a and 3b, motors 5a and 5b including drive shafts 10a and 10b are fixed, respectively. And, in addition, on the calipers 3a and 3b, electric motor-driven pistons 4a and 4b are attached so that they shift in the left-hand and right-hand directions of FIG. 3 when they are driven by the motors 5a and 5b, respectively.

The motors 5a and 5h are three-phase motors each of which has a stator including thereon one group of coil windings with respect to a single disc rotor. The electric motor-driven brake device includes the controllers (electric power converters) 6a and 6h for supplying electric power to the motors 5a and 5b and also for controlling the operations (rotational directions, rotational speeds and torque), and the electric power source 7 for supplying electric power to the controllers 6a and 6h and for receiving electric power therefrom. And, by supplying electric power from the controllers 6a and 6b to the motors 5a and 5b, the drive shafts 10a and 10b rotate normally or reversely, so that the electric motor-driven pistons 4a and 4h shift reciprocally in the axial direction (left-hand and right-hand directions of FIG. 3), respectively. Here, the controllers 6a and 6b are connected so that the one group of coil windings of the motors 5a and 5b each can be energized, respectively.

The operational examples, and the details of each of the items and components are equivalent or similar to those in Embodiment 1, and thus their explanation will be omitted.

In this embodiment, the configuration is so arranged that the two three-phase motors 5a and 5b are driven by means of the controllers 6a and 6b, and that the two electric motor-driven pistons 4a and 4b are operated, respectively. As for sensor inputs for the operations by driving each of the motors, it is so configured that an output of the load sensor 8a and that of the rotation angle sensor 9a are inputted into the controller 6a, and that an output of the load sensor 8h and that of the rotation angle sensor 9b are inputted into the controller 6b.

In addition, signals of the stroke sensors 11a and 11b are also inputted into the controllers 6a and 6b, respectively. As for the information of these signals, the controllers 6a and 6b calculate target values of decelerating- and braking-force required for a wheeled vehicle, or pressing force required for obtaining such force, based on the stroke-quantity signals. Moreover, in accordance with these target values, decelerating- and braking-force of the wheeled vehicle and a pressure-load(s) are controlled.

As described above, the controllers 6a and 6b are configured in such a manner that they can drive the motors 5a and 5b, independent of each other, by independently using input information, a calculation value (s) and a detection value(s), respectively.

For the controllers 6a and 6b each, inputs of the stroke sensors are provided, and target values of decelerating- and braking-force required for the wheeled vehicle, or pressing force required for obtaining such force are calculated by both of the controllers. And thus, even when an input of a stroke sensor into one controller is disconnected or when a controller malfunctions, it becomes possible to continue the controls by using a calculation result(s) of the other controller, so that the electric motor-driven brake device appropriately enables a wheeled vehicle running and stopping as it usually does, even in a case in which a malfunction is caused in a component(s) related to the electric motor-driven brake device of the wheeled vehicle. In addition, the controllers 6a and 6b are intensively made into the single-piece electric motor-drive unit 13 that is integrally configured as one unit as shown in FIG. 3, and also, in addition to the functions to drive the motors 5a and 5b, the controllers 6a and 6b are also given to carry the function to calculate from various kinds of sensor inputs target values of decelerating- and braking-force required for the wheeled vehicle, or pressing force required for obtaining such force, so that, on the occasion to make individual functions dual-redundant as a system, it is possible to cope only with the increase of an interface or with that of an input circuit without creating another unit; and thus, it is possible to implement those functions with low costs.

### Embodiment 3

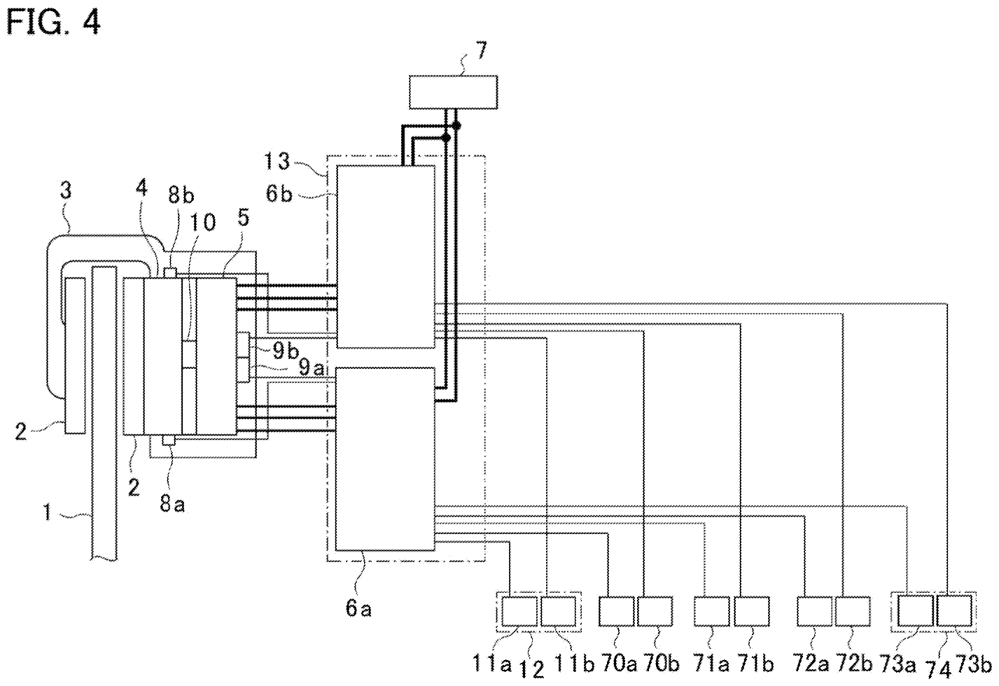

The explanation will be made referring to FIG. 4 for a configuration of an electric motor-driven brake device. FIG. 4 illustrates a schematic diagram for explaining the configuration of the electric motor-driven brake device according to Embodiment 3.

FIG. 4 is configured in such a manner that, with respect to the configuration of FIG. 1, wheeled vehicle sensors made as a dual-redundant system are additionally mounted for detecting wheeled-vehicle information of a wheeled vehicle. To be specific, additionally mounted as the wheeled vehicle sensors are various kinds of wheeled vehicle sensors such as: automotive wheel-speed sensors 70a and 70b (first automotive wheel-speed sensor 70a and second automotive wheel-speed sensor 70b) each for detecting speeds of automotive wheels, acceleration sensors 71a and 71b (first acceleration sensor 71a and second acceleration sensor 71b) each for detecting acceleration of the wheeled vehicle, yaw rate sensors 72a and 72b (first yaw rate sensor 72a and yaw rate sensor 72b) each for detecting a yaw rate of the wheeled vehicle, and steering angle sensors 73a and 73b (first steering angle sensor 73a and second steering angle sensor 73b) each for detecting a steering angle of a steering device 74 mounted on the wheeled vehicle. Namely, these wheeled vehicle sensors are individually constituted of a first wheeled vehicle sensor and a second wheeled vehicle sensor forming a pair with each other. Note that, the various kinds of wheeled vehicle sensors are not limited to these listed above.

A signal line of the automotive wheel-speed sensor 70a, a signal line of the acceleration sensor 71a, a signal line of the yaw rate sensor 72a and a signal line of the steering angle sensor 73a are connected to the controller 6a, and a signal line of the automotive wheel-speed sensor 70b, a signal line of the acceleration sensor 71b, a signal line of the yaw rate sensor 72b and a signal line of the steering angle sensor 73b are connected to the controller 6b.

The controllers 6a and 6b calculate target values of decelerating- and braking-force required for the wheeled vehicle, or pressing force required for obtaining such force, based on the information of the quantity of stroke, and additionally on at least any one piece more pieces of information among the information of an automotive wheel-speed(s), that of acceleration, that of a yaw rate (s) and that of a steering angle(s). According to this arrangement, the electric motor-driven brake device further appropriately enables a wheeled vehicle running and stopping as it usually does, to more extent than a case in which the calculation is carried out only from the quantity of stroke. To be specific, by calculating a target value(s) to perform wheeled vehicle controls such as an ABS control for curbing lockup of an automotive wheel (s) at the time of deceleration, an ESC control for curbing a sideways skid of a wheeled vehicle, a traction management control for curbing skids of a wheeled vehicle at the time of its start off and so forth, the electric motor-driven brake device appropriately enables the wheeled vehicle running and stopping as it usually does.

In addition to the above, when the electric motor-driven brake devices are mounted on a wheeled vehicle, decelerating- and braking-force on each of automotive wheels of the wheeled vehicle, or pressing force required for obtaining such force is independently calculated for each of automotive wheels, and also, the decelerating- and braking-force, or the pressing force required for obtaining such force can be independently controlled for each of automotive wheels. And thus, such a wheeled vehicle control of curbing pitching of a wheeled vehicle and rolling thereof, and such a wheeled vehicle control of a wheeled vehicle to corner in a smaller radius can also be implemented, and by introducing such wheeled vehicle controls, it becomes also possible to enhance the comfortableness and convenience of a vehicle occupant(s) of the wheeled vehicle.

How the target values of decelerating- and braking-force, or pressing force required for obtaining such force are calculated in what ways is not an object of the present disclosure of the application concerned, and thus their detailed explanation will be omitted.

In addition, in the configuration of FIG. 4, two of respective sensors are mounted, and these sensors are inputted into the controllers 6a and 6b with each other; however, it may appropriately be configured in such a way that one of the respective sensors each is mounted instead, and, by branching off the sensor output thereof, such branched outputs are individually inputted into the controllers 6a and 6b. In this case, sensor costs can be curbed. Although there arise a possibility to introduce constraints on a wheeled vehicle control (s) at the time of a sensor malfunction, it is possible for the wheeled vehicle control (s) using the electric motor-driven brake device to cope with a disconnection of a signal line(s) between a sensor and a controller(s) without introducing constraints.

As described above, the controllers 6a and 6b are configured in such a manner that they can individually drive the motor 5 by independently using input information, a calculation value(s) and a detection value(s).

For the controllers 6a and 6b each, inputs of the stroke sensors, the automotive wheel-speed sensors, the acceleration sensors, the yaw rate sensors and the steering angle sensors are provided, and target values of decelerating- and braking-force required for a wheeled vehicle, or pressing force required for obtaining such force are calculated by both of the controllers. And thus, even when an input of each of the sensors into one controller is disconnected or when a controller malfunctions, it becomes possible to continue wheeled vehicle controls including the ABS control, the ESC control and the like by using a calculation result(s) of the other controller, so that the electric motor-driven brake device appropriately enables a wheeled vehicle running and stopping as it usually does, even in a case in which a malfunction is caused in a component (s) related to the electric motor-driven brake device of the wheeled vehicle. In addition, the controllers 6a and 6b are intensively made into the single-piece electric motor-drive unit 13 that is integrally configured as one unit as shown in FIG. 4, and also, in addition to the function to drive the motor 5, the controllers 6a and 6b are also given to carry the function to calculate from various kinds of sensor inputs target values of decelerating- and braking-force required for the wheeled vehicle, or pressing force required for obtaining such force, so that, on the occasion to make individual functions dual-redundant as a system, it is possible to cope only with the increase of an interface or with that of an input circuit without creating another unit; and thus, it is possible to implement those functions with low costs.

Moreover, in this embodiment, the motor 5 is described as a dual-winding three-phase motor; however, similar effects can be obtained in a configuration of the three-phase motors 5a and Sb adopted in such a manner as shown in FIG. 3, and also in the configuration of driving the three-phase motor 5a by the controller 6a and in that of driving the three-phase motor Sb by the controller 6b.

### Embodiment 4

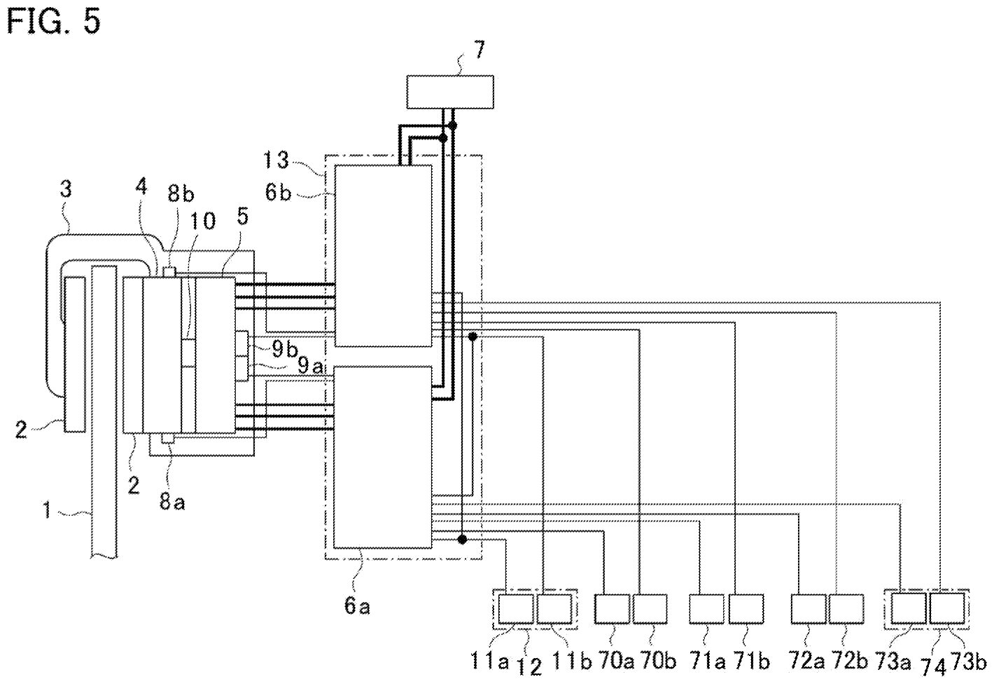

The explanation will be made referring to FIG. 5 for a configuration of an electric motor-driven brake device. FIG. 5 illustrates a schematic diagram for explaining the configuration of the electric motor-driven brake device according to Embodiment 4; because its explanation has been described above in detail, its detailed explanation will be omitted.

In Embodiment 4, the connections between the stroke sensors 11a and 11b, and the respective controllers 6a and 6b differ from those of Embodiment 3. To be specific, a signal line of the stroke sensor 11a is connected to both of the controllers 6a and 6b, and a signal line of the stroke sensor 11b is connected to both of the controllers 6a and 6b.

Into both of the controllers 6a and 6b, the two signals of the stroke sensors 11a and 11b are separately inputted, so that, by using the information of these signals, abnormality of a stroke sensor can be detected; and thus, the performance as a wheeled vehicle is enhanced.

### Embodiment 5

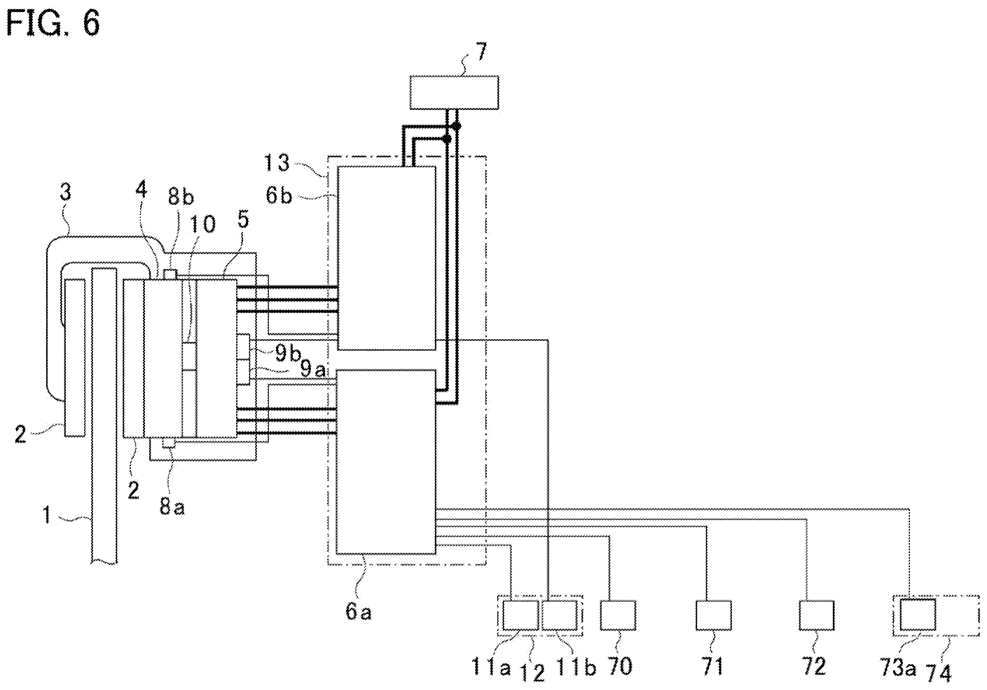

The explanation will be made referring to FIG. 6 for a configuration of an electric motor-driven brake device. FIG. 6 illustrates a schematic diagram for explaining the configuration of the electric motor-driven brake device according Embodiment 5.

In FIG. 6, with respect to the configuration of FIG. 4, an automotive wheel-speed sensor 70, an acceleration sensor 71, a yaw rate sensor 72 and a steering angle sensor 73, each belongs to various kinds of wheeled vehicle sensors, are not made as a dual-redundant system, but are individually made as a single sensor, so that a signal line of the automotive wheel-speed sensor 70, a signal line of the acceleration sensor 71, a signal line of the yaw rate sensor 72 and a signal line of the steering angle sensor 73 are connected to the controller 6a. Note that, the signal lines of these various kinds of wheeled vehicle sensors may not be connected to the controller 6a, but connected to the controller 6b instead.

In the controller 6a, calculated are target values of decelerating- and braking-force required for a wheeled vehicle, or pressing force required for obtaining such force, based on the information of the quantity of stroke, and additionally on at least any one piece or more pieces of information among the information of an automotive wheel-speed(s), that of acceleration, that of a yaw rate(s) and that of a steering angle(s). According to this arrangement, the electric motor-driven brake device further appropriately enables the wheeled vehicle running and stopping as it usually does, to more extent than a case in which the calculation is carried out only from the quantity of stroke. To be specific, a target value (s) is calculated so as to perform wheeled vehicle controls such as an ABS control for curbing lockup of an automotive wheel(s) at the time of deceleration, an ESC control for curbing a sideways skid of a wheeled vehicle, a traction management control for curbing skids of a wheeled vehicle at the time of its start off, and so forth; and, in the controller 6b, a target value(s) of decelerating- and braking-force required for the wheeled vehicle, or pressing force required for obtaining such force is calculated, based on the information of the quantity of stroke.

It is configured in such a manner that a controller which calculates from the information of the quantity of stroke a target value (s of decelerating- and braking-force required for a wheeled vehicle, or pressing force required for obtaining such force is made as a dual-redundant system, and meanwhile that a controller which carries the ABS control and the ESC control is not made as a dual-redundant system. According to this arrangement, the number of sensors can be reduced, so that it becomes possible to achieve lower costs. In the configuration, depending on a position of malfunction in the electric motor-driven brake device, it is no more possible to perform wheeled vehicle controls such as the ABS control, the ESC control and the like, due to a malfunction caused at one position; however, by continuously calculating from the quantity of stroke a target value(s) of decelerating- and braking-force required for the wheeled vehicle, or pressing force required for obtaining such force, and by controlling the decelerating- and braking-force or the pressing force by the controller(s), the electric motor-driven brake device appropriately enables the wheeled vehicle running and stopping as it usually does.

### Embodiment 6

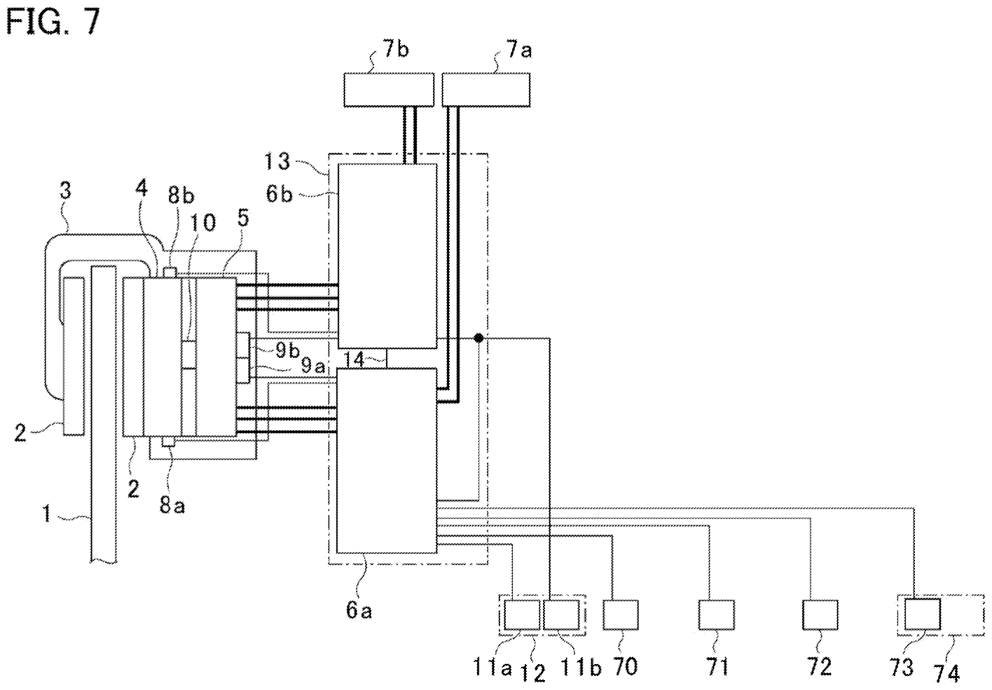

The explanation will be made referring to FIG. 7 for a configuration of an electric motor-driven brake device. FIG. 7 illustrates a schematic diagram for explaining the configuration of the electric motor-driven brake device according to Embodiment 6; because its explanation has been described above in detail, its detailed explanation will be omitted.

In Embodiment 6, the connections between the stroke sensors 11a and 11b, and the controller 6a differ from those of Embodiment 5. To be specific, a signal line of the stroke sensor 11b is connected to both of the controllers 6a and 6b.

In addition, the electric motor-driven brake device is configured in such a manner that the controllers 6a and 6b are connected to different electric power sources so as to perform electric power supply/reception therebetween, and hence that an electric power source 7a for supplying electric power to the controller 6a and for receiving electric power therefrom, and an electric power source 7b for supplying electric power to the controller 6b and for receiving electric power therefrom are included.

The controllers 6a and 6b are electrically insulated from each other, so that it is so arranged that an influence is not exerted on a controller on the other side, even when an electric power source on one side is lost, and/or when a signal line thereon or an electric power line thereon is disconnected. For this reason, the communications line 14 connecting between the controller 6a and the controller 6b is electrically insulated, which can be achieved by using, for example, photocouplers, a differential amplifier circuit(s), or the like.

Into the controller 6a, the two signals of the stroke sensors 11a and 11b are together inputted, so that, by using the information of these signals, abnormality of a stroke sensor can be detected; and thus, the performance as a wheeled vehicle is enhanced.

To the controller 6a, a signal line of an automotive wheel-speed sensor, that of an acceleration sensor, that of a yaw rate sensor, that of a steering angle sensor 73 and so forth are connected in addition to signal lines of the stroke sensors, so that, based on those signals, the controller has the function to calculate a target value(s) of decelerating-and braking-force required for a wheeled vehicle, or pressing force required for obtaining such force for carrying out the ABS control, the ESC control, and so forth; and thus, the controller can acquire higher performance than the controller 6b. By implementing the configuration of Embodiment 6, it is possible to heighten the performance of the electric motor-driven brake device.

### Embodiment 7

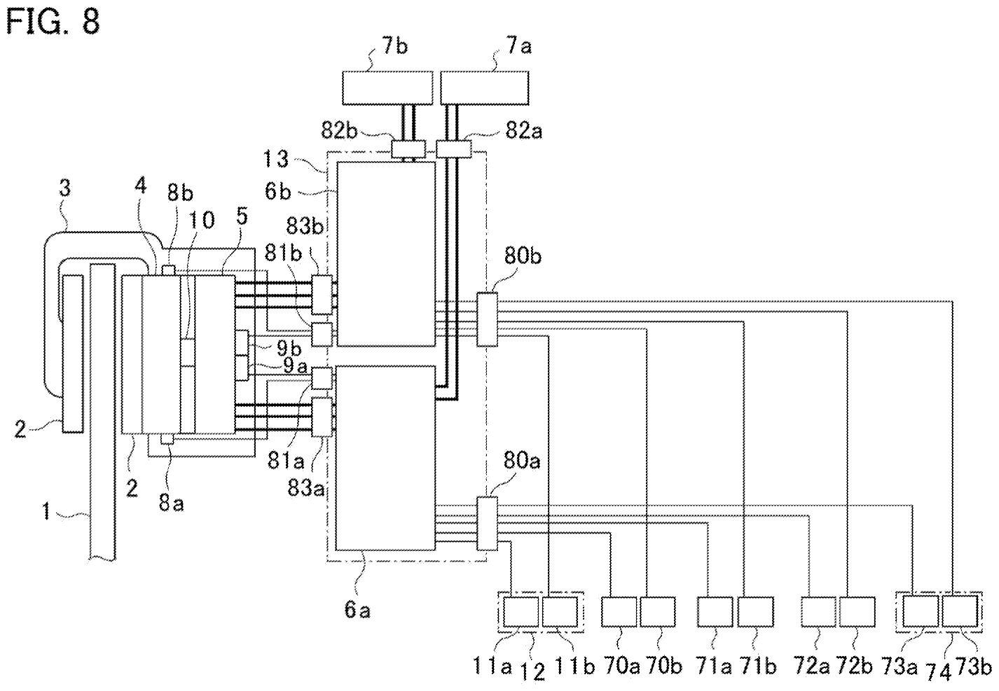

The explanation will be made referring to FIG. 8 for a configuration of an electric motor-driven brake device. FIG. 8 illustrates a schematic diagram for explaining the configuration of the electric motor-driven brake device according to Embodiment 7; because its explanation has been described above in detail, its detailed explanation will be omitted.

In Embodiment 7, additionally mounted on the electric motor-drive unit 13 are its connectors for connecting the electric motor-drive unit 13 to each of signal lines all of which constitute the electric motor-driven brake device described in Embodiment 3, and those for connecting the electric motor-drive unit to each of electric power lines in Embodiment 7.

A signal line of the stroke sensor 11a, a signal line of the automotive wheel-speed sensor 70a, a signal line of the acceleration sensor 71a, a signal line of the yaw rate sensor 72a, and a signal line of the steering angle sensor 73a are connected to the controller Ga by way of a connector 80a; and a signal line of the stroke sensor 11b, a signal line of the automotive wheel-speed sensor 70b, a signal line of the acceleration sensor 71b, a signal line of the yaw rate sensor 72h, and a signal line of the steering angle sensor 73b are connected to the controller 6b by way of a connector 80b.

In addition, a signal line of the rotation angle sensor 9a and a signal line of the load sensor 8a are connected to the controller 6a by way of a connector 81a, and a signal line of the rotation angle sensor 9b and a signal line of the load sensor 8b are connected to the controller 6h by way of a connector 81b.

Moreover, between two groups of coil windings of the motor 5, three-phase electric power lines connecting one group of coil windings are connected to the controller Ga by way of a connector 83a, and three-phase electric power lines connecting the other group of coil windings are connected to the controller 6b by way of a connector 83b.

In addition to the above, electric power lines of the electric power source 7a are connected to the controller 6a by way of a connector 82a, and electric power lines of the electric power source 7b are connected to the controller 6b by way of a connector 82b.

According to the above, by assigning different connectors for signal lines connected to the controllers 6a and 6b, and those for electric power lines connected thereto, for example, an input(s) for calculating a target value(s), and all of the signal lines and electric power lines required for driving the motor 5 are connected to either one of the controllers 6a and 6b, even when any one of the connectors is lost; and thus, it is possible to continue the calculation of a target value(s), and the control of decelerating- and braking-force or pressing force. By implementing the configuration of Embodiment 7, it is possible to heighten the performance of the electric motor-driven brake device.

Here, in the electric motor-drive unit 13 of this embodiment, connectors of the signal lines and connectors of the electric power lines are separately included in the number of four; however, in order to achieve lower costs by reducing the number of those connectors, it is also applicable even when the connectors are separately made in the number of two. To be specific, it is suitable to configure that, even when any one of the connectors is lost, an input(s) for calculating a target value(s), and all of the signal lines and electric power lines required for driving the motor 5 are connected to either one of the controllers 6a and 6b; and thus, it may be adopted that connecters of signal lines are made of two by combining the connector 80a and the connector 81a and by combining the connector 80b and the connector 81b, and that connectors of the electric power lines are made of two by combining the connector 82a and the connector 83a and by combining the connector 82b and the connector 83b. These are examples, and so there is a plurality of configurations and combinations of the connectors in which, even when any one of the connectors is lost, an input(s) for calculating a target value(s), and all of the signal lines and electric power lines required for driving the motor 5 are connected to either one of the controllers 6a and 6b; and thus, similar effects can also be obtained according to such configurations and combinations. Their detailed explanation will be omitted for the configurations and combinations.

In addition to the above, because the connectors 80a and 80b interconnect similar signal lines, the number of components is cut down by using the connectors of the same shape, so that it becomes possible to achieve lower costs. In another manner, in order to avoid a plug-in connection error of the connectors, the connectors 80a and 80b may be made in shape differing from each other. Similar manners are applicable in the combination of the connectors 81a and 81b, the combination of the connectors 82a and 82b, and the combination of the connectors 83a and 83b.

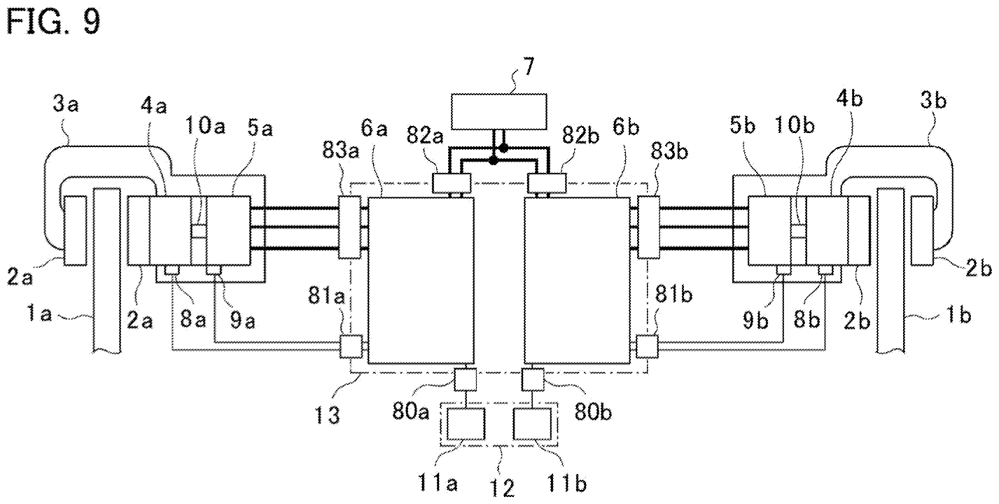

Moreover, in this embodiment, the motor 5 is described as a dual-winding three-phase motor; however, similar effects can be obtained in a configuration of the three-phase motors 5a and 5b adopted in such a manner as a modification example illustrated in FIG. 9, and also in the configuration of driving the three-phase motor 5a by the controller 6a and in that of driving the three-phase motor 5b by the controller 6b.

The configurations described in Embodiments 1 through 7 each are examples. It is similarly possible to obtain those effects even in the configurations as described below. For example, as for the motor current sensors in FIG. 2, the shunt resistors built in the controllers are used; however, it may be adopted that those are non-contacting type sensors placed on the three-phase lines. Moreover, as a caliper structure, the explanation has been made for pressing on one side; however, the caliper structure may also be such a structure to achieve pressing on both sides. In addition to the above, the configuration is so arranged that a three-phase motor is presumed as in FIG. 2; however, the motor may also be suitable for a brush motor. In addition, in FIG. 1 and FIGS. 3 through 9, a motor(s) and an electric motor-driven piston ((s) are described in such an arrangement that they are directly linked; however, a reduction gear(s) may be mounted between the motor(s) and the electric motor-driven piston(s). Moreover, as sensors for use in wheeled vehicle controls, an automotive wheel-speed sensor, an acceleration sensor, a yaw rate sensor and a steering angle sensor are described as examples; however, it is not necessarily limited to those as the sensors for use in wheeled vehicle controls. For example, a sensor for detecting pitching of a wheeled vehicle or rolling thereof is mounted thereon, and a similar configuration may be appropriately implemented. Furthermore, acceleration sensors may be mounted in forward and rearward directions, left-hand and right-hand directions and/or upward and downward directions with respect to a vehicle-proceeding direction of a wheeled vehicle, and thus, the acceleration sensors are selectable depending on a wheeled vehicle control(s) which is intendedly performed. In addition to the above, as for configurations of electric power source 7, there arise a configuration in which the controllers 6a and 6b are connected to the same electric power source 7, and a configuration in which the controllers 6a and 6b are connected to the different electric power sources 7a and 7b, respectively. In Embodiments 1 through 7, the explanation has been made by referring to a device configuration shown on one side or on the other; however, it is also applicable even when the device configuration is reversed from one side to the other.

The electric motor-driven brake devices described in Embodiments 1 through 7 each can be mounted on a wheeled vehicle by combining them with one another. For example, when an application is made for a wheeled vehicle having four wheels at the front and rear, and at the left and right, electric motor-driven brake devices may be mounted on all of the four wheels, or electric motor-driven brake devices may be mounted on only the two front wheels or only the two rear wheels.

In the present disclosure of the application concerned, various exemplary embodiments and implementation examples are described; however, various features, aspects and functions described in one or a plurality of embodiments are not necessarily limited to the applications of a specific embodiment(s), but are applicable in an embodiment(s) solely or in various combinations.

Therefore, limitless modification examples not being exemplified can be presumed without departing from the scope of the technologies disclosed in Specification of the disclosure of the application concerned. For example, there arise cases which are included as a case in which at least one constituent element is modified, added or eliminated, and further a case in which at least one constituent element is extracted and then combined with a constituent element(s) of another embodiment.

What is claimed is:

1. An electric motor-driven brake device, comprising:
a disc rotor for rotating together with an axle of an automotive wheel of a wheeled vehicle;
a brake pad for producing braking force of the wheeled vehicle by means of pressing said brake pad against said disc rotor;
an electric motor-driven piston, being driven a motor, for pressing said brake pad against said disc rotor, or for disengaging said brake pad from said disc rotor;
an electric motor-drive device for controlling drive of said electric motor-driven piston by controlling said motor; and
a stroke sensor for detecting a quantity of stroke of a brake pedal,
the electric motor-driven brake device for controlling braking force on said automotive wheel of the wheeled vehicle by means of the electric motor-drive device in accordance with a quantity of stroke being detected, wherein
the electric motor-drive device comprises a first controller and a second controller for driving said motor, and
a signal line of said stroke sensor is connected to both of the first controller and the second controller.

2. An electric motor-driven brake device, comprising:
a disc rotor for rotating together with an axle of an automotive wheel of a wheeled vehicle;
a brake pad for producing braking force of the wheeled vehicle by means of pressing said brake pad against said disc rotor;
an electric motor-driven piston, being driven by a motor, for pressing said brake pad against said disc rotor, or for disengaging said brake pad from said disc rotor;
an electric motor-drive device for controlling drive of said electric motor-driven piston by controlling said motor; and
a first stroke sensor and a second stroke sensor each for detecting a quantity of stroke of a brake pedal,
the electric motor-driven brake device for controlling braking force on said automotive wheel of the wheeled vehicle by means of the electric motor-drive device in accordance with a quantity of stroke being detected, wherein
the electric motor drive device comprises a first controller and a second controller for driving said motor; and
a signal line of the first stroke sensor is connected to the first controller, and a signal line of the second stroke sensor is connected to the second controller.

3. The electric motor-driven brake device as set forth in claim 2, further comprising
a wheeled vehicle sensor for detecting wheeled-vehicle information of the wheeled vehicle,
the electric motor-driven brake device for controlling braking force on said automotive wheel of the wheeled vehicle in accordance with wheeled-vehicle information from said wheeled vehicle sensor by means of the electric motor drive device, wherein
a signal line of said wheeled vehicle sensor is connected to both of the first controller and the second controller.

4. The electric motor-driven brake device as set forth in claim 3, wherein
said wheeled vehicle sensor comprises a first wheeled vehicle sensor and a second wheeled vehicle sensor forming a pair with each other, and, in the electric motor-driven brake device for controlling braking force on said automotive wheel of the wheeled vehicle in accordance with wheeled-vehicle information detected by said first wheeled vehicle sensor or said second wheeled vehicle sensor,
a signal line of said first wheeled vehicle sensor is connected to the first controller, and a signal line of said second wheeled vehicle sensor is connected to the second controller.

5. The electric motor-driven brake device as set forth in claim 3, wherein a signal line of the first stroke sensor is connected to both of the first controller and the second controller, and a signal line of the second stroke sensor is connected to both of the first controller and the second controller.

6. The electric motor-driven brake device as set forth in claim 2, further comprising
a wheeled vehicle sensor for detecting wheeled-vehicle information of the wheeled vehicle,
the electric motor-driven brake device for controlling braking force on said automotive wheel of the wheeled vehicle in accordance with wheeled-vehicle information from said wheeled vehicle sensor by means of the electric motor-drive device, wherein
a signal line of said wheeled vehicle sensor is connected to the first controller

7. The electric motor-driven brake device as set forth in claim 6, wherein a signal line of the first stroke sensor is connected to the first controller, and a signal line of the second stroke sensor is connected to both of the first controller and the second controller.

8. The electric motor-driven brake device as set forth in claim 4, wherein the electric motor-drive device is provided with a connector for connecting a signal line of said stroke sensor and that of said wheeled vehicle sensor to the first controller and to the second controller.

9. The electric motor-driven brake device as set forth in claim 4, wherein the electric motor-drive device includes a first connector for connecting a signal line of the first stroke sensor to the first controller, and a second connector for connecting a signal line of the second stroke sensor to the second controller.

10. The electric motor-driven brake device as set forth in claim 9, wherein the first connector connects a signal line of said first wheeled vehicle sensor to the first controller, and the second connector connects a signal line of said second wheeled vehicle sensor to the second controller.

11. The electric motor-driven brake device as set forth in claim 1, wherein the first controller and the second controller are connected through a communications line.

12. The electric motor-driven brake device as set forth in claim 11, wherein the communications line is electrically insulated.

13. The electric motor-driven brake device as set forth in claim 1, wherein
said motor comprises a dual-winding three-phase motor having a stator including thereon two independent groups of coil windings with respect to a single rotor; and
said motor is driven by the first controller and the second controller.

14. The electric motor-driven brake device as set forth in claim 13, wherein the dual-winding three-phase motor includes a first rotation angle sensor for detecting a rotational position of the dual-winding three-phase motor, and a second rotation angle sensor for detecting that of the dual-winding three-phase motor.

15. The electric motor-driven brake device as set forth in claim 14, wherein a signal line of the first rotation angle sensor is connected to the first controller, and a signal line of the second rotation angle sensor is connected to the second controller.

16. The electric motor-driven brake device as set forth in claim 15, wherein the electric motor-drive device includes a third connector for connecting a signal line of the first rotation angle sensor to the first controller, and a fourth connector for connecting a signal line of the second rotation angle sensor to the second controller.

17. The electric motor-driven brake device as set forth in claim 13, wherein said electric motor-driven piston includes a first load sensor and a second load sensor each for detecting a pressure-load when said brake pad is pressed against said disc rotor.

18. The electric motor-driven brake device as set forth in claim 17, wherein a signal line of the first load sensor is connected to the first controller, and a signal line of the second load sensor is connected Lo the second controller.

19. The electric motor-driven brake device as set forth in claim 18, wherein the electric motor-drive device includes a third connector for connecting a signal line of the first load sensor to the first controller, and a fourth connector for connecting a signal line of the second load sensor to the second controller

20. The electric motor-driven brake device as set forth in claim 1, wherein
said motor comprises a first three-phase motor and a second three-phase motor each of which has a stator Including thereon one independent group of coil windings with respect to a single rotor; and
the first three-phase motor is driven by the first controller, and the second three-phase motor is driven by the second controller.

21. The electric motor-driven brake device as set forth in claim 20, wherein
said disc rotor comprises a first disc rotor and ci second disc rotor attached on different automotive wheels from each other, and the electric motor-driven brake device includes:
a first brake pad, by means of pressing it against the first disc rotor, for producing braking force of the wheeled vehicle;
a first electric motor-driven piston, being driven by the first three-phase motor, for pressing the first brake pad against the first disc rotor, or for disengaging the first brake pad from the first disc rotor;
a second brake pad, by means of pressing it against the second disc rotor, for producing braking force of the wheeled vehicle; and
a second electric motor-driven piston, being driven by the second three-phase motor, for pressing the second brake pad against the second disc rotor, or for disengaging the second brake pad from the second disc rotor, wherein
a first rotation angle sensor is mounted on the first three-phase motor for detecting a rotational position of the first three-phase motor;
a first load sensor is mounted on the first motor-driven piston for detecting a pressure-load when the first brake pad is pressed against the first disc rotor;
a second rotation angle sensor is mounted on the second three-phase motor for detecting a rotational position of the second three-phase motor; and
a second load sensor is mounted on the second motor-driven piston for detecting a pressure-load when the second brake pad is pressed against the second disc rotor.

22. The electric motor-driven brake device as set forth in claim 21, wherein the electric motor-drive device includes a third connector for connecting a signal line of the first load sensor and that of the first rotation angle sensor L the first controller, and a fourth connector for connecting a signal line of the second load sensor and that of the second rotation angle sensor to the second controller.

23. The electric motor-driven brake device as set forth in claim 9, wherein the first connector and the second connector differ in shape from each other.

24. The electric motor-driven brake device as set forth in claim 16, wherein the third connector and the fourth connector differ in shape from each other.

25. The electric motor-driven brake device as set forth in claim 1, further comprising
an electric power source for supplying electric power to the electric motor-drive device, wherein
the electric motor-drive device includes a first power-system connector for connecting an electric power line of said electric power source to the first controller, and a second power-system connector for connecting an electric power line of said electric power source to the second controller.

26. The electric motor-driven brake device as set forth in claim 1, further comprising
an electric power source for supplying electric power to the electric motor-drive device, wherein
the electric motor-drive device includes a third power-system connector for connecting an electric power line of said motor to the first controller, and a fourth power-system connector for connecting an electric power line of said motor to the second controller.

27. The electric motor-driven brake device as set forth in claim 25, wherein the first power-system connector and the second power-system connector differ in shape from each other.

28. The electric motor-driven brake device as set forth in claim 26, wherein the third power-system connector and the fourth power-system connector differ in shape from each other.

29. The electric motor-driven brake device as set forth in claim 3, wherein said wheeled vehicle sensor includes at least any one sensor or more of an automotive wheel-speed sensor for detecting a speed of said automotive wheel of the wheeled vehicle, an acceleration sensor for detecting acceleration of the wheeled vehicle, a yaw rate sensor for detecting a yaw rate of the wheeled vehicle, and a steering angle sensor for detecting a steering angle of a steering device mounted on the wheeled vehicle.
